(19) United States
(12) Patent Application Publication
(10) Pub. No.: US 2026/0305853 A1
(43) Pub. Date: Oct. 8, 2026

(54) Integrated Dispensing and Disposal Caddy

(71) Applicants: Vincent E. Lamberti, OAK RIDGE, TN (US); Arthur C. Miller, JR., KNOXVILLE, TN (US); Michael J. Renner, OAK RIDGE, TN (US)

(72) Inventors: Vincent E. Lamberti, OAK RIDGE, TN (US); Arthur C. Miller, JR., KNOXVILLE, TN (US); Michael J. Renner, OAK RIDGE, TN (US)

(21) Appl. No.: 19/171,730

(22) Filed: Apr. 7, 2025

(51) Int. Cl. A47G 19/30; B65F 1/14

(52) U.S. Cl. CPC A47G 19/30; B65F 1/1426

(57) ABSTRACT

An apparatus having a compartment for holding items to be dispensed is integrated with a receptacle bin for receiving and storing the used dispensed items until the bin is emptied. The apparatus is principally useful in the food and personal products industries where secure and sanitary temporary storage of waste is highly beneficial, as well as easy access to and cleaning of the apparatus. Eating establishments can beneficially deploy the apparatus as a single-level or multi-level table caddy for various items such as sugar and tea packets, condiments, napkins, and the like.

### FIELD

This disclosure relates generally to the food service and personal products industries. More particularly, this disclosure relates to dispensing and disposing of items contained in a caddy.

### BACKGROUND

Many dining facilities such as restaurants, cafeterias, and fast-food outlets place a caddy on a table for holding and dispensing certain items. Typically, such items may include among other things, sugar and sweetener packets, salt and pepper packets, tea bags, creamers, jelly packets, ketchup and mustard packets, sanitary wipes, and napkins. Properly disposing of such used items by customers during a meal in a safe, sanitary, and sightly manner is a problem. Often, the used packet is placed on the table or perhaps on the main plate or a side plate for the duration of the meal. When such packets fall on the floor, they can pose a danger to others of slipping on the packets, particularly if the item contains a fluid or gel, such as cream, ketchup or jelly. In addition, some customers lick their fingers while squeezing the fluid or gel out of the packet, which leaves a small amount of bodily fluid on the packet to create an unsanitary condition for the restaurant's clean-up staff. Further, when tables are outside, wind forces can carry the used packets off the premises to spread the unsafe, unsanitary, and unsightly litter.

What is needed to solve these problems and others is an apparatus that integrates a receptacle bin with the caddy to store used caddy packets and items until the disposal bin is periodically emptied by a restaurant's wait staff. The present disclosure satisfies this need in a simple yet novel and effective manner.

### SUMMARY

The present disclosure provides a caddy that can be used on a table, counter or other surface of an eating establishment that has a least one dispensing container which holds packets such as sugar, sweetener, salt, condiments and the like for dispensing the packets, and an integrated receptacle bin for receiving and storing used packets and wrappers until the bin is emptied. Further, the caddy is configured to permit easy emptying of the receptacle bin while unused packets and wrappers remain securely within the dispensing compartment, and to permit easy cleaning of the caddy. Advantageous materials may be chosen to survive multiple cycles in a restaurant-style dishwasher and mechanical insults like being dropped from table height. It will be appreciated that such a caddy may be used in other environments, including industry sectors offering wrapped personal products such as health and cosmetic products.

In one illustrative embodiment, a single-level caddy has at least one dispensing compartment and at least one receptacle bin, and a retainer secured to a sidewall of the caddy wherein the retainer has a fixed portion and an adjustable portion approximately perpendicular to the fixed portion. The fixed portion of the retainer has a closed position wherein the fixed portion obstructs access to a dispensing compartment but does not obstruct access to the receptacle bin, so that when the caddy is inverted to empty the receptacle bin, the fixed portion retains the packets within the dispensing compartment while at the same time allowing any waste to freely empty from the receptacle bin. The fixed portion of the retainer also has an open position that does not obstruct access to the dispensing compartment or to the receptacle bin, thereby enabling users to freely extract packets from the dispensing compartment and to freely dispose of waste packets into the receptacle bin and to enable wait staff to freely remove waste from the receptacle bin.

In another illustrative embodiment, a multi-level caddy has one or more dispensing compartments having an interior space and one or more receptacle bins having an interior space wherein a portion of the interior space of the receptacle bin is disposed beneath a portion of the interior space of the dispensing compartment. The dispensing compartment has at least one sidewall joined to a bottom wall that together form the interior space of the dispensing compartment. The receptacle bin also has at least one sidewall joined to a bottom wall that together form the interior space of the receptacle bin. At least one sidewall of the receptacle bin has an opening. To aid removal of waste from the receptacle bin, a sidewall of the receptacle bin may be hinged to another sidewall or to the bottom wall, and a sidewall or the bottom wall may be removable. The dispensing compartment and the receptacle bin may be permanently or removably attached to each other.

In yet another illustrative embodiment, a multi-level caddy has a portion of an interior space of one or more receptacle bins disposed beneath a portion of an interior space of one or more dispensing compartments. A passageway through which waste may be deposited connects the interior space of the dispensing compartment to the interior space of the receptacle bin. The passageway may be sited centrally or at another beneficial location of the multi-level caddy. The multi-level caddy may have circular or other desired shape. The dispensing compartment and the receptacle bin may be permanently or removably attached to each other.

### BRIEF DESCRIPTION OF THE DRAWINGS

Various advantages are apparent by reference to the detailed description in conjunction with the figures, wherein elements are not to scale so as to more clearly show the details, wherein like reference numbers indicate like elements throughout the several views, and wherein:

FIG. 1 is a perspective view of a single-level caddy with one dispensing compartment according to one embodiment of the disclosure.

FIG. 1A depicts the caddy of FIG. 1 with a retainer in a closed position.

FIG. 1B depicts the caddy of FIG. 1 with a retainer in an open position.

FIG. 1C depicts the caddy of FIG. 1 with a retainer in an open position having a telescoping section.

FIG. 1D is an end view of the caddy of FIG. 1 having a connector assembly with a closed channel.

FIG. 1E depicts the caddy of FIG. 1D where the connector assembly has a partially open channel.

FIG. 1F is a side view depicting a retainer with a stub end inserted through a hole in a sidewall of the caddy of FIG. 1 and securely attached to the sidewall with an end cap.

FIG. 1G is a perspective view depicting a retainer with a stub end for insertion into a vertical slot in a sidewall of the caddy of FIG. 1 for securely attaching the retainer to the sidewall with an end cap.

FIG. 2 is a perspective view of a single-level caddy having multiple dispensing compartments separated by a receptacle bin and with a retainer in a closed position.

FIG. 2A is a perspective bottom view of the caddy depicted in FIG. 2 with the retainer in an open position beneath the caddy.

FIG. 3 is a perspective view of a multi-level caddy with a sidewall of a receptacle bin having an opening according to another embodiment of the disclosure.

FIG. 4 depicts the caddy of FIG. 3 wherein a dispensing compartment and a receptacle bin are removably attached with a mechanical securing mechanism having opposing arrays of tapered teeth-like ridges.

FIG. 4A depicts the caddy of FIG. 3 wherein a dispensing compartment and a receptacle bin are removably attached with a mechanical securing mechanism having locking pins cooperating with locking slots.

FIG. 5 depicts the caddy of FIG. 3 with a separator rod having two segments that may be joined together or separated.

FIG. 5A depicts the caddy of FIG. 3 with a separator rod residing within a housing that separates the dispensing compartment from the receptacle bin and wherein the separator rod and dispensing compartment have rotated.

FIG. 6 is a perspective view of a circular shaped multi-level caddy with a central passageway connecting a dispensing compartment with a receptacle bin, and wherein the dispensing compartment and receptacle bin are removably attached with locking pins cooperating with locking slots.

FIG. 7 is a perspective view of a circular shaped multi-level caddy with a central passageway connecting a dispensing compartment with a receptacle bin, and wherein a separating rod has two segments that may be joined together or separated.

FIG. 7A is a perspective view of a circular shaped multi-level caddy with a central passageway connecting a dispensing compartment with a receptacle bin, and wherein a separator rod residing within a housing separates the dispensing compartment from the receptacle bin.

### DETAILED DESCRIPTION

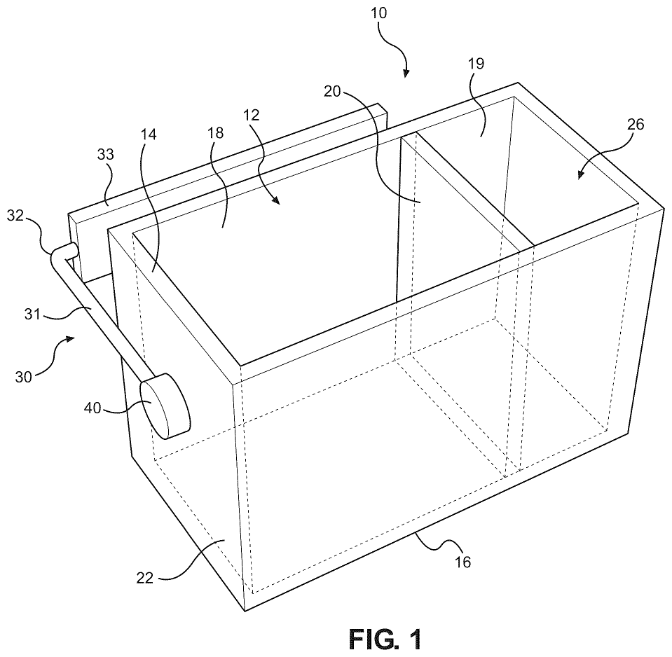

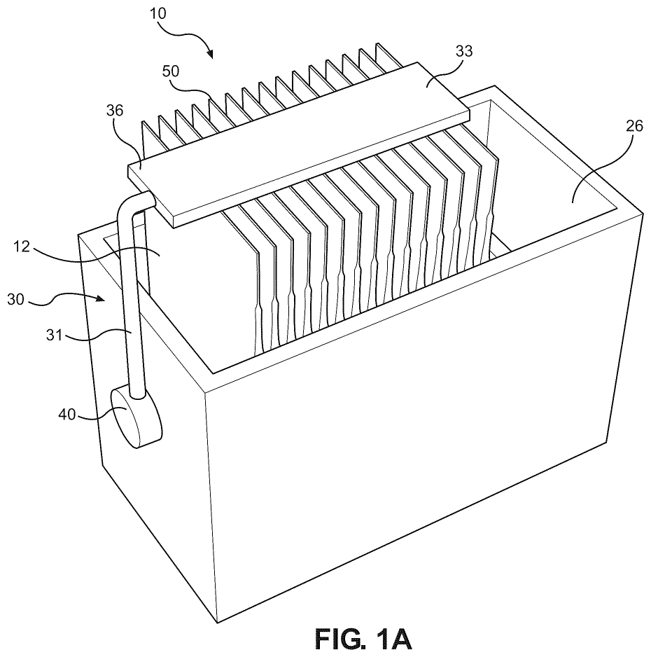

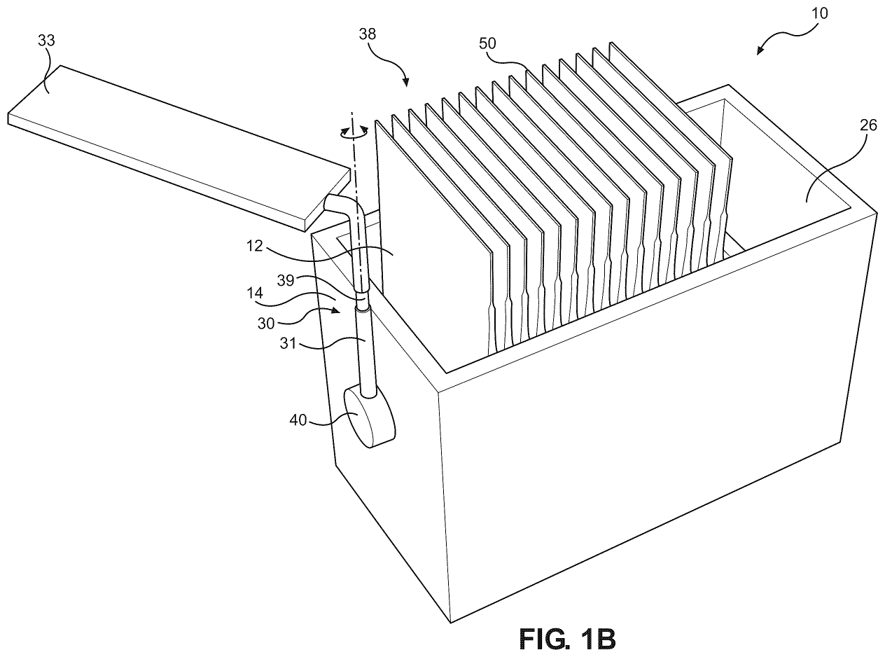

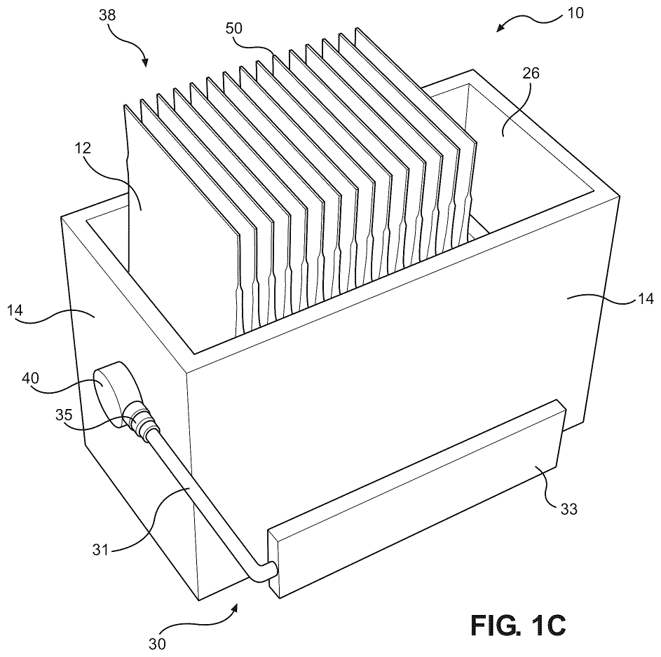

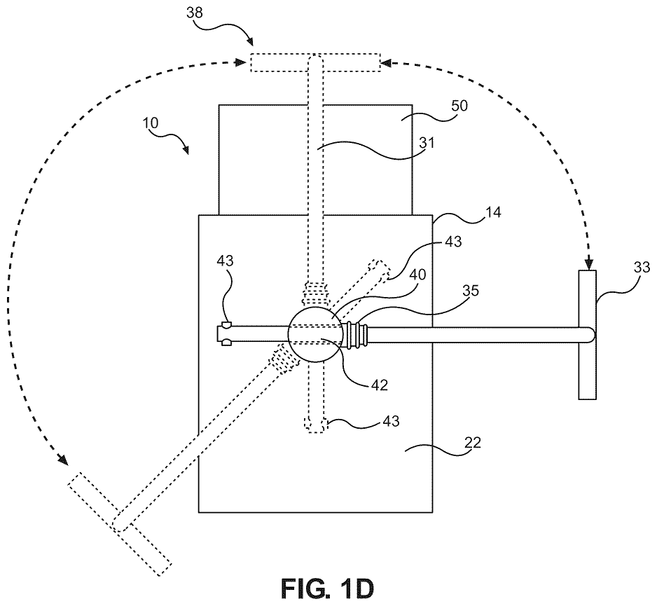

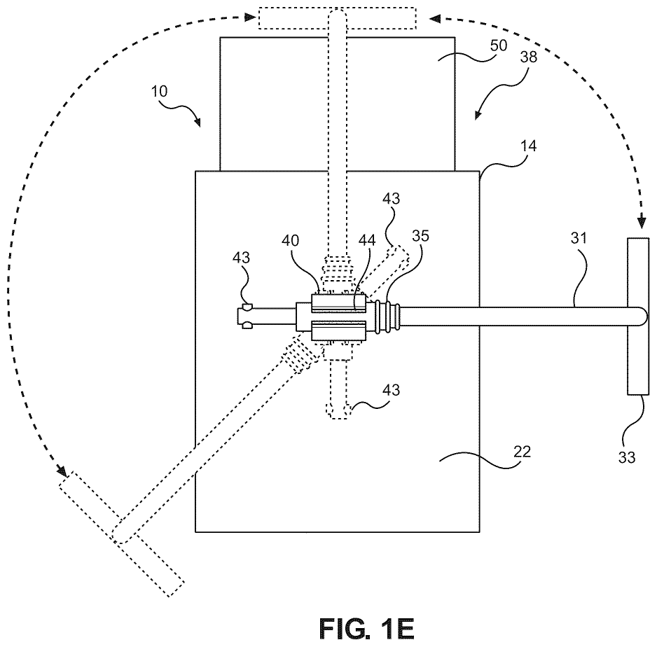

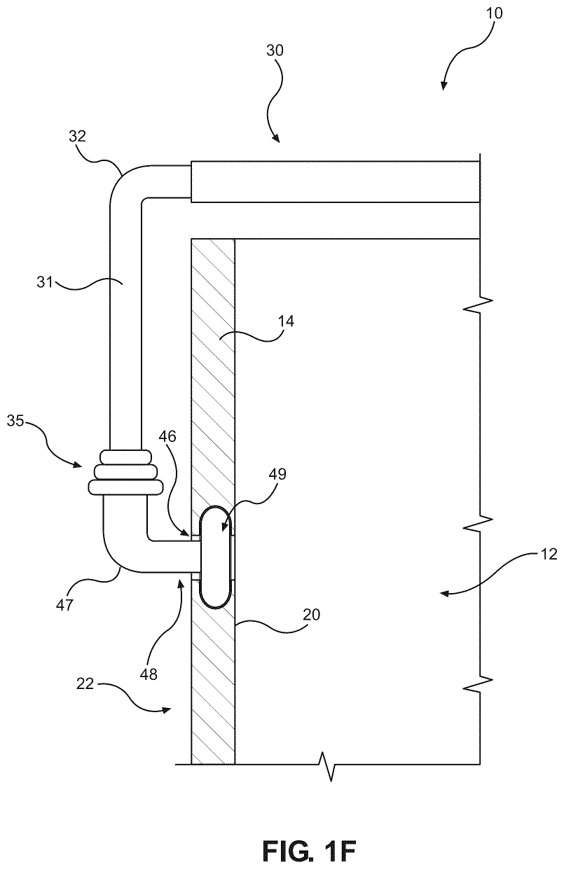

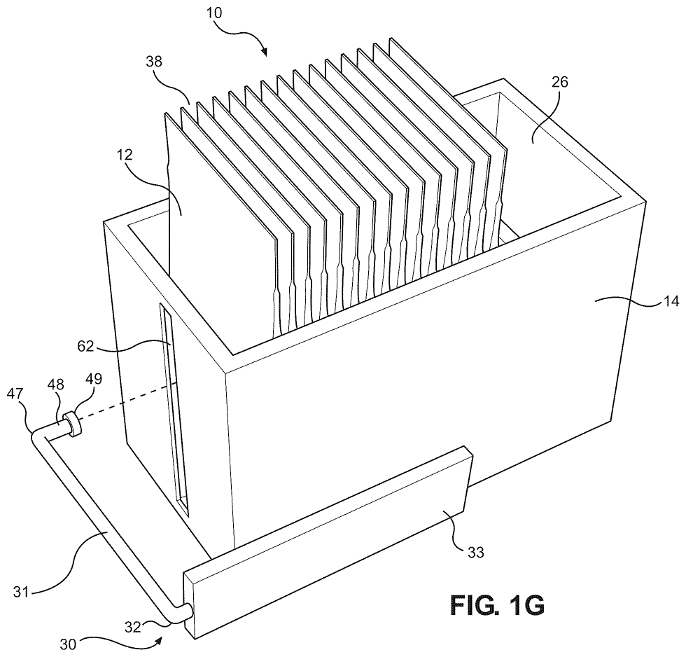

In one illustrative embodiment as shown in FIG. 1, a single-level caddy 10 has at least one dispensing compartment 12 and at least one receptacle bin 26. A dispensing compartment 12 is formed by joining a plurality of sidewalls 14 with a bottom wall 16 to create an interior space 18. Each sidewall and bottom wall of dispensing compartment 12 has an interior surface 20 that when joined together define interior space 18. Similarly, receptacle bin 26 is formed by joining a plurality of sidewalls with a bottom wall that together create an interior space 19 within receptacle bin 26. Further, each sidewall of single-level caddy 10 has an exterior surface 22. Optionally, receptacle bin 26 has a lid that can aid containment of waste in windy environments and screen unsightly waste from view. A retainer 30 is secured to a sidewall 14 of single-level caddy 10 with optional connector assembly 40, and wherein the retainer is configured with an adjustable portion 31 having a first end 32 joined at an angle to a fixed portion 33 and wherein said angle is preferably approximately a right angle to fixed portion 33. As used in this disclosure, the term “single-level caddy” means no portion of interior space 19 of receptacle bin 26 is disposed beneath a portion of interior space 18 of dispensing compartment 12.

Single-level caddy 10 is configured to allow the fixed portion of the retainer to alternate between being in a closed position and an open position. As defined herein, the closed position is where the fixed portion of the retainer obstructs access to the dispensing compartment but does not obstruct access to receptacle bin. In contrast, the open position as defined herein is where the fixed portion of the retainer does not obstruct access to the dispensing compartment or access to the receptacle bin.

FIG. 1A shows single-level caddy 10 in closed position 36 wherein fixed portion 33 of retainer 30 obstructs access to dispensing compartment 12 but does not obstruct access to receptacle bin 26, so that when single-level caddy 10 is inverted to empty the receptacle bin, fixed portion 33 retains the items to be dispensed, such as packets 50 and the like, within dispensing compartment 12 while at the same time allowing any waste within receptacle bin 26 to empty freely. Typically, when fixed portion 33 is in closed position 36, it is substantially parallel the bottom wall of dispensing compartment 12 so that, for example, it is also substantially parallel the exposed upper portion of packets 50.

FIG. 1B shows the single-level caddy 10 of FIG. 1A in an open position 38 with fixed portion 33 turned so that it does not obstruct access to the dispensing compartment and any contents within. As shown, adjustable portion 31 optionally is a swivel and thus turns itself and connected fixed portion 33 due to swivel section 39. Adjustable portion 31 may also turn itself and connected fixed portion 33 within a suitably hollowed portion of optional assembly connector 40 (not shown).

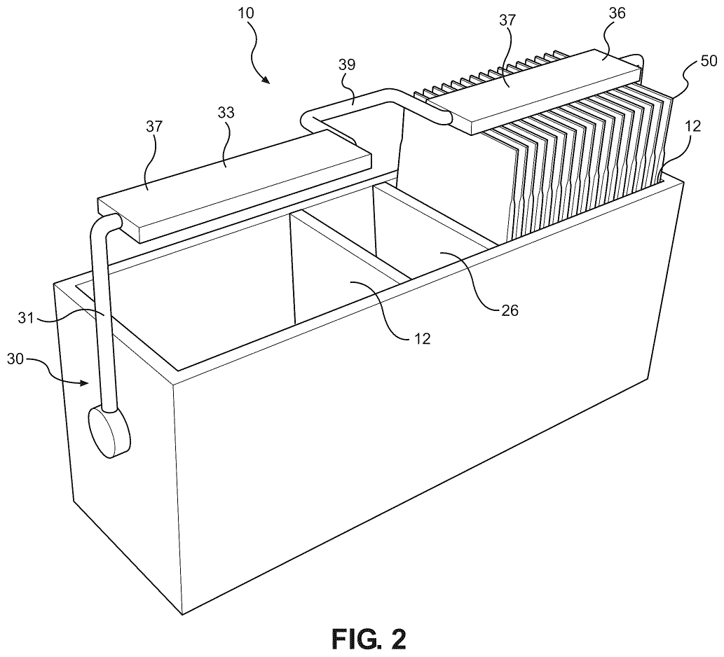

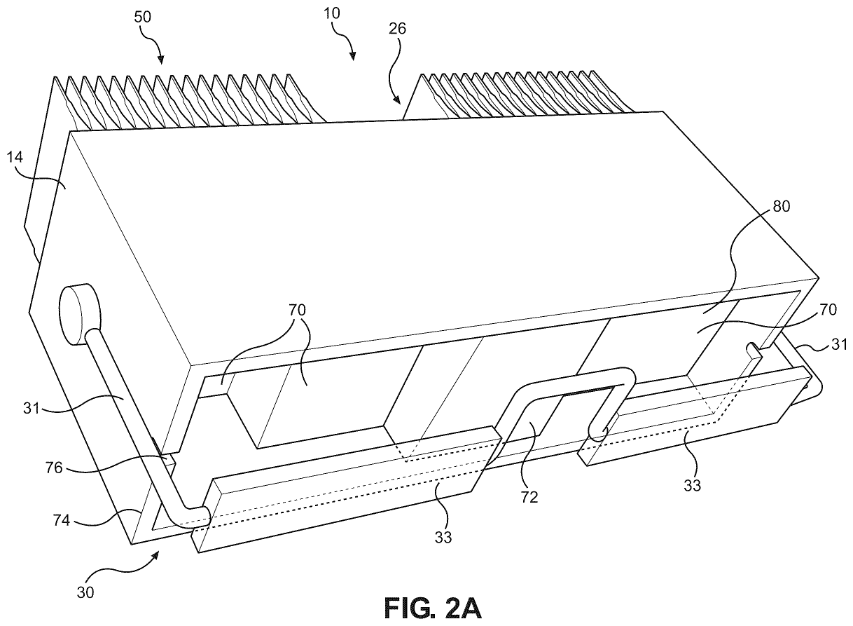

It will be appreciated that open position 38 contemplates other convenient locations for fixed portion 33 to be in the open position, such as a height sufficiently above dispensing compartment 12 to allow unobstructed adding and extracting of packets 50, a location beneath single-level caddy 10 as later shown in FIG. 2A, and other locations, including locations such as that shown in FIG. 1C. With further reference to FIG. 1C, adjustable portion 31 of retainer 30 includes optional telescoping section 35. Said telescoping section enables adjustable portion 31 to extend sufficiently for fixed portion 33 to achieve open position 38 at a convenient location and to retract sufficiently for fixed portion 33 to achieve closed position 36. Still referring to FIG. 1C, optional connector assembly 40 is configured to rotate at least 180 degrees to allow fixed portion 30 to rotate between closed position 36 and a location beneath single-caddy 10. As shown in FIG. 1C, telescoping section 35 has extended so that fixed portion 33 has sufficient height to clear the edge of packets 50, and connector assembly 40 has rotated so that fixed portion 33 rests against sidewall 14 in open position 38.

Referring now to FIG. 1D, optional connector assembly 40 is secured to an exterior surface 22 of sidewall 14. Said connector assembly 40 optionally is configured with a closed channel 42 in which a portion of adjustable portion 31 resides, and in which said channel said portion may turn and through which said channel said portion may translate parallel (adjustable portion 31 may turn or translate or do both) that same exterior surface 22 so that adjustable portion 31 turns and/or extends and retracts a distance measured from connector assembly 40 to achieve a desired open position 38 or closed position 36. As shown, closed channel 42 has a hole through its entire length in which adjustable portion 31 has achieved open position 38 by translating and rotating along with the connector assembly. In this configuration, adjustable portion 31 is preferably tubular in shape and hollow, but may be solid and have a different shape, such as star-shaped, so long as the friction at the points of contact between adjustable portion 31 and the inside walls of closed channel 42 (which friction may be enhanced with rubber or other advantageous material at the points of contact) is sufficient to prevent adjustable portion 31 from slipping due to gravity. Adjustable portion 31 includes protrusions 43 below closed channel 42 to prevent adjustable portion 31 from being extracted from connector assembly 40. Optionally, the protrusion may be push-buttons that can be depressed to intentionally extract or reinsert adjustable portion 31. Optionally, adjustable portion 31 may include telescoping section 35.

FIG. 1E shows another configuration of optional connector assembly 40 secured to an exterior surface 22 of sidewall 14. Said connector assembly optionally is configured with a partially open channel 44, in which said channel adjustable portion 31 may turn and through which it may translate parallel (it may turn or translate or do both) that same exterior surface 22 so that adjustable portion 31 turns and/or extends and retracts a distance from connector assembly 40 to achieve a desired open position 38 or closed position 36. Adjustable portion 31 may also rotate as the connector assembly rotates. The distance between the two edges forming the length of the opening of partially open channel 44 is sufficiently narrow to secure adjustable portion 31 within partially open channel 44 yet sufficiently wide to permit removal from partially open channel 44. Partially open channel 44 optionally may include at least some flexible material, preferentially along at least one of the two edges forming the length of said channel to aid removal and insertion of adjustable portion 31. In this configuration, adjustable portion 31 may be hollow or solid and may have tubular or other shape. Where such shape is not tubular, such as rectangular, adjustable assembly 31 will translate but may or may not turn within the channel. Adjustable portion 31 includes protrusions 43 below partially open channel 44 to prevent adjustable portion 31 from being extracted from connector assembly 40. Optionally, the protrusion may be push-buttons that can be depressed to intentionally extract adjustable portion 31. Optionally, adjustable portion 31 may include telescoping section 35.

In FIG. 1F, retainer 30 is shown optionally secured to sidewall 14 without connector assembly 40. An exterior surface 22 of a sidewall 14 has a hole 46. Adjustable portion 31 has a second end 47 opposite first end 32 wherein second end 47 is configured with a stub segment 48. Stub segment 48 is at least partially inserted through hole 46 and is configured to prevent stub segment 48 from unintentionally exiting hole 46 and detaching retainer 30 from sidewall 14, wherein such configuration of stub segment 48 may comprise one of an end cap 49 such as shown in FIG. 1E, a cotter pin assembly (not shown), and the like. Optionally, it will be appreciated that stub segment 48 in cooperation with another portion of retainer 30 may be under spring-like tension to prevent stub segment 48 from unintentionally exiting hole 46 without having an end cap or cotter pin assembly. Stub segment 48 is at an angle to the remainder of adjustable portion 31 and the angle may be a right angle as depicted in FIG. 1E. Stub segment 48 is typically tubular in shape and end cap 49 is typically circular so that together they rotate adjustable portion 31 between closed and various open positions while rotating within the hole and sidewall, respectively. As shown, end cap 49 is residing between exterior surface 22 and interior surface 20 of the same sidewall 14. Although not shown, it will be appreciated that stub segment 48 may extend through hole 46 and through sidewall 14 into dispensing compartment 12 so that end cap 49 resides within dispensing compartment 12 and, more beneficially, completely resides within a recess of interior surface 20 so as not to interfere with packets 50. Adjustable portion 31 further includes telescoping section 35.

FIG. 1G shows another configuration where retainer 30 is secured to sidewall 14 of single-level caddy 10 without connector assembly 40. Sidewall 14 has a vertical slot 62 that does not extend to either the top or the bottom of sidewall 14. Adjustable portion 31 has a second end opposite first end 32 wherein second end 47 is configured with a stub segment 48 fitted with an end cap 49, wherein the diameter of end cap 49 is greater than the horizontal width of slot 62. End cap 49 and a portion of stub segment 48 are inserted into and optionally beyond the slot so that adjustable portion 31 may slide up and down along slot 62 to allow fixed portion 33 to achieve an open position or a closed position. Stub segment 48 is typically tubular in shape and end cap 49 is typically circular so that together they rotate adjustable portion 31 between closed and various open positions while rotating within or beyond slot 62.

In yet other embodiments of single-level caddy 10, retainer 30 may be secured to sidewall 14 with an adhesive, or with screws, or with brackets, or magnetically, or when manufactured together as a single piece such as through extrusion or additive manufacturing, wherein adjustable portion 31 is configured with telescoping section 35 or with a swivel, or both.

FIG. 2 shows single-level caddy 10 having multiple dispensing compartments 12 separated by receptacle bin 26 and further showing retainer 30 with fixed portion 33 in closed position 36. As shown, fixed portion 33 is configured to have multiple segments 37 that obstruct access to each dispensing compartment 12 when in closed position 36, and to have a joining piece 39 that connects segments 37 but does not obstruct access to receptacle bin 26 when in closed position 36. For additional visual clarity but without limitation, FIG. 2 further shows one dispensing compartment 12 that is empty while the other contains packets 50. Optionally, retainer 30 may include a second adjustable portion 31 configured the same as the first adjustable portion 31 wherein retainer 30 is attached to the cooperating sidewall of a second dispensing container in the same manner as it is attached to the first dispensing compartment as described and shown previously in this disclosure. Such additional portion of retainer 30 beneficially adds sturdiness to retainer 30, particularly when retainer 30 is used as a handle while transporting single-level caddy 10. Retainer 30 is secured to a sidewall of single-level caddy 10 by one of the methods previously described in this disclosure.

Turning to FIG. 2A, fixed portion 33 is shown rotated beneath single-level caddy 10. Also shown are bottom walls 70 of multiple dispensing compartments 12 and bottom wall 72 of receptacle bin 26. Optionally, bottom walls 70 and 72 may be immovably fixed at uniform or various distances from a bottom edge 74 of sidewalls 14, wherein uniform distances of bottom walls 70 from bottom edge 74 create dispensing compartments having uniform depth, and wherein various distances of bottom walls 70 from bottom edge 74 create at least one dispensing compartment having a depth that varies from the depth of at least one other dispensing compartment. Optionally, bottom walls 70 and 72 are adjustable in depth and may be placed or moved to have uniform or various distances from bottom edge 74 of sidewalls 14, wherein uniform distances of bottom walls 70 from bottom edge 74 create dispensing compartments having uniform depth, and various distances of bottom walls 70 from bottom edge 74 create at least one dispensing compartment having a depth that varies from the depth of at least one other dispensing compartment. It will be appreciated that dispensing compartments having various depths beneficially aid retainer 30 while in closed position in obstructing unintentional exiting of packets 50 when single-level caddy 10 is inverted by decreasing the distance between fixed portion 33 and packets 50 when dispensing compartments contain packets of various height, such as typical sugar packets as well as typically smaller salt or pepper packets. It will be further appreciated that the location of dispensing compartment sidewalls may vary the width of dispensing compartments and that said sidewall locations may be fixed or adjustable.

Referring still to FIG. 2A, and by way of example, the bottom walls 70 of multiple dispensing compartments 12 are shown located at different depths from bottom edge 74. Optionally, bottom walls 70 and 72 are located at a distance from bottom edge 74 of sidewalls 14 to form a cavity 80 beneath all the bottom walls of single-level caddy 10, wherein said cavity 80 is sufficient to house fixed portion 33 of retainer 30 when adjustable portion 31 is retracted and rotated to place fixed portion 33 beneath single caddy 10. A notch 76 is provided at bottom edge 74 of the particular sidewall 14 secured to retainer 30, and a cooperating like-notch is situated in the bottom edge of the cooperating sidewall of a second dispensing compartment when retainer 30 is additionally configured with optional second adjustable portion 31 as previously described in reference to FIG. 2. Notch 76 allows fixed portion 33 of retainer 30 to reside (not shown) within cavity 80 and within notch 76 without obstruction from said sidewall 14.

In some embodiments, a multi-level caddy has one or more dispensing compartments and one or more receptacle bins. As used throughout this disclosure, the term “multi-level caddy” means a portion of the interior space of the receptacle bin is disposed beneath a portion of the interior space of the dispensing compartment. According to the disclosure, the dispensing compartment and receptacle bin may have a plurality of sidewalls, or the dispensing department and receptacle bin may have only one sidewall, where, for example, the single sidewall forms a circle, oval, ellipse, or other shape. Where the multi-level caddy is circular in shape, the circumference of the single sidewall of the dispensing compartment and the circumference of the single sidewall of the receptacle bin are approximately the same length.

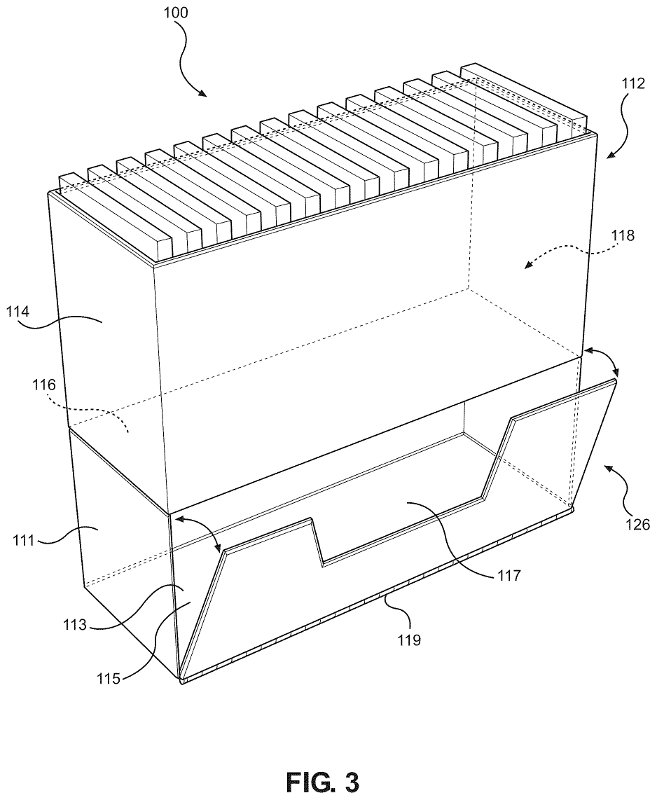

FIG. 3 shows one embodiment of a multi-level caddy 100 wherein dispensing compartment 112 is formed by joining a plurality of sidewalls 114 with a bottom wall 116 that together create an interior space 118. FIG. 3 further shows receptacle bin 126 formed by joining a plurality of sidewalls 111 with a bottom wall 113 to create an interior space 115. A portion of interior space 115 of receptacle bin 126 is disposed beneath a portion of interior space 118 of dispensing compartment 112. Optionally, at least one sidewall 111 of receptacle bin 126 has an opening 117 through which waste packets may be injected into and emptied from receptacle bin 126.

Optionally, multi-level caddy 100 may be configured with one or more hinges to access the interior space to aid removal of waste from receptacle bin 126. As further shown in FIG. 3, sidewall 111 and bottom wall 113 of receptacle bin 126 are joined by hinge 119. It will be appreciated that hinge 119 and opening 117 may be disposed on different sidewalls 111, but when hinge 119 and opening 117 are disposed on the same sidewall 111 as shown, the opening 117 aids the engagement of hinge 119 to empty receptacle bin 126. Optionally, hinge 119 may join two sidewalls 111 to allow one sidewall to rotate outward from said receptacle bin. Optionally, a sidewall or bottom wall of receptacle bin 126 may be removable from said receptacle bin to aid emptying of said receptable bin, such as when a sidewall or bottom wall is configured with tongue and groove edges, when a sidewall and bottom wall are magnetically attached, when such sidewall and bottom wall are adhesively attached for example with a hook and loop fastener, and the like.

Optionally, dispensing compartment 112 may be permanently secured to receptacle bin 126, or the dispensing compartment may simply rest on top of the receptacle bin. Optionally, dispensing compartment 112 may be attached to and detached from receptacle bin 126. Such removable attachment may be accomplished with a mechanical securing mechanism, magnetically, or adhesively for example with a hook and loop fastener, and the like. When said dispensing compartment and receptacle bin are attached, the caddy is beneficially more resistant to accidental toppling and the attached pieces are easier to transport than two separate pieces. When said dispensing compartment and receptacle bin are detached from each other, the receptacle bin is easier to empty and the caddy is easier to clean.

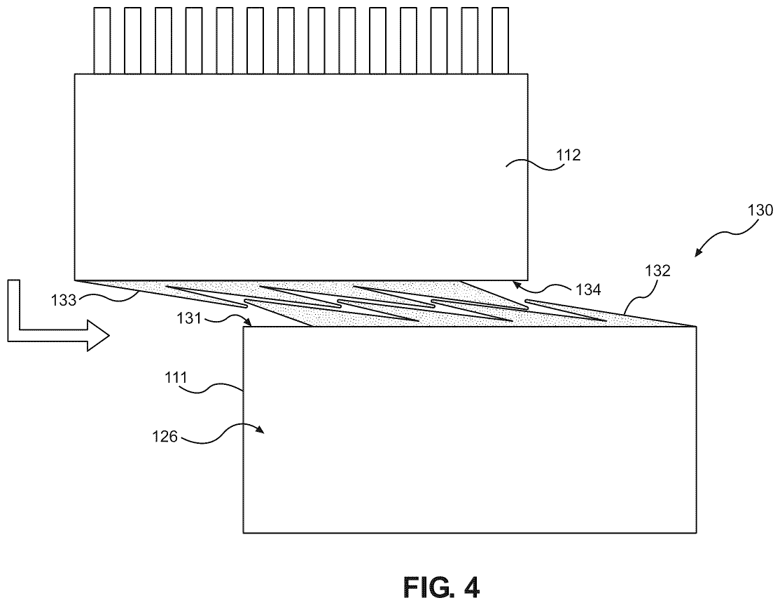

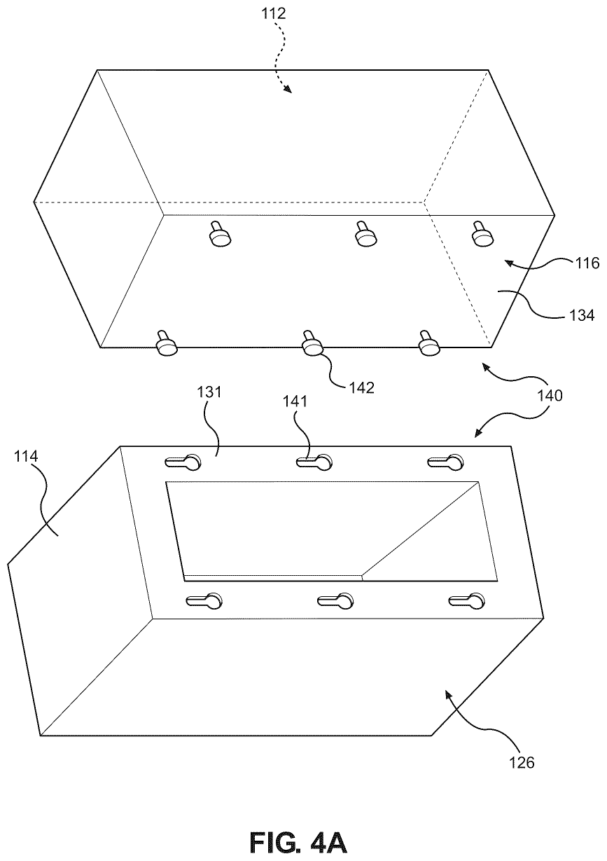

An exemplary mechanical securing mechanism 130 is shown in FIG. 4, wherein sidewalls 111 of receptacle bin 126 have a top edge 131 approximately perpendicular to said sidewalls, and wherein a first teeth-like array of tapered ridges 132 is disposed at a less than 90-degree angle on top edge 131 of receptacle bin 126. A cooperating second teeth-like array of tapered ridges 133 is disposed on the exterior surface 134 of bottom wall 116 of dispensing compartment 112 wherein the direction of the second array 133 faces directly opposite the direction of the first array, and the angle formed at the junction of the second array 133 and bottom wall 116 has the same degrees of angle as the angle formed at the junction of the first array 132 and top edge 131. The first array 132 tapers from its widest where it attaches to top edge 131, and the second array tapers from its widest where it attaches to bottom wall 116. The angle of attachment of the first array beneficially cooperates with the opposing angle of attachment of the second array so that the two opposing arrays fit snugly together when interleaved to secure with friction the dispensing compartment to the receptacle bin, but yet can be retracted from each other to detach the dispensing compartment from the receptacle bin. It will be understood that as the angle of attachment decreases, the friction increases between the opposing arrays when said arrays are interleaved. Beneficially, the angle of attachment is less than 30 degrees, and more beneficially less than 20 degrees, and still more beneficially less than 15 degrees. Optionally, the arrays may comprise hardened rubber or other suitable material that increases friction when interleaved. FIG. 4 depicts a side view of second array 133 moving downward and to the right to interleave with first array 132.

Another exemplary mechanical securing mechanism 140 is shown in FIG. 4A, wherein sidewalls 114 of receptacle bin 126 have a top edge 131 approximately perpendicular to said sidewalls, and wherein top edge 131 has locking slots 141for receiving and securing locking pins 142 cooperatively disposed on the exterior surface 134 of bottom wall 116 of dispensing compartment 112.

Optionally, dispensing compartment 112 and receptacle bin 126 may be attached to each other with a separator rod. The separator rod may be secured to an exterior surface of the bottom wall of the dispensing compartment and to an inside surface of the bottom wall of the receptacle bin. Alternatively, the separator rod is secured to the dispensing compartment and to the receptacle bin using other apparent combinations of surfaces, such as to an outside surface of a sidewall of the dispensing compartment and to the outside surface of the cooperating sidewall of the receptacle bin.

Optionally, the separator rod has a first end which resides within a first housing attached to either the receptacle bin or the dispensing compartment. The first housing allows the separator rod to rotate within it so that at least one of the bottom surfaces of the dispensing compartment and receptacle bin rotate parallel to the other bottom surface in the same plane when a lateral force is applied to the dispensing compartment or receptacle bin. Optionally, a second end of the separator rod may reside and rotate within a second housing. Optionally, the separator rod may rotate when it is configured as a swivel.

The separator rod length may be fixed or it may be extendable when configured with a telescoping portion. A separator rod with a telescoping portion may be additionally configured to have a first end disposed within a first housing to allow the separator rod to rotate within it.

Optionally, the separator rod may have two or more segments that may be detached from and reattached to each other and thereby attach and detach dispensing compartment 112 and receptacle bin 126. Such configuration for removable attachment is yet another exemplary mechanical securing mechanism. Optionally, the separator rod may be a single piece.

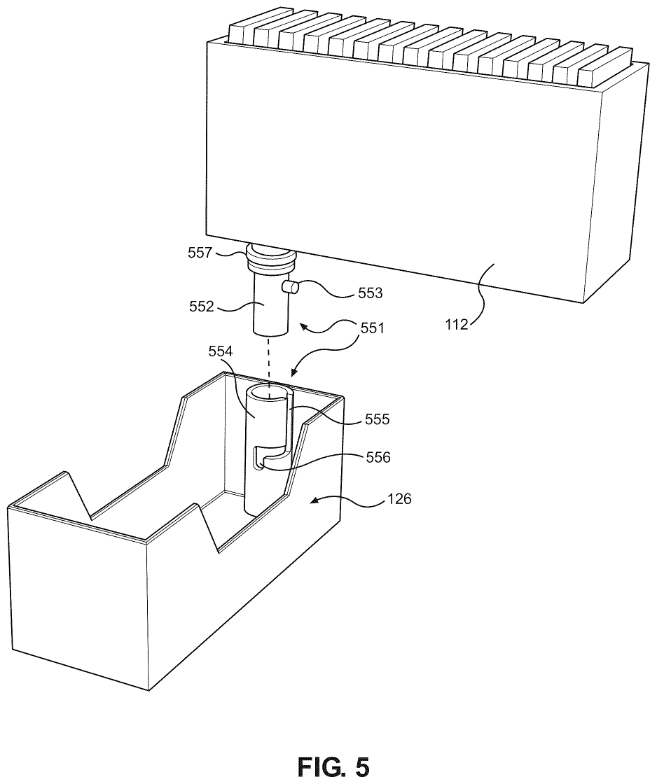

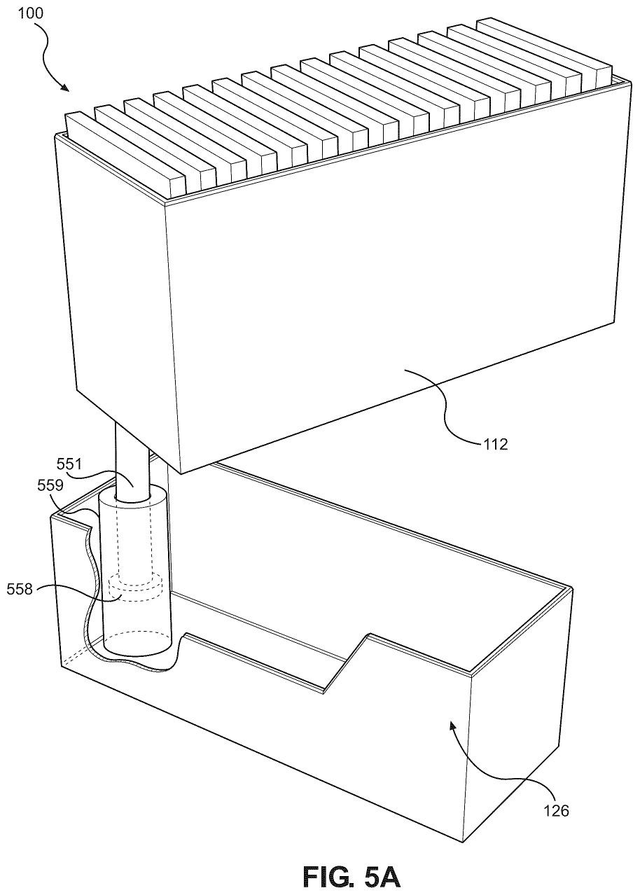

FIG. 5 shows separator rod 551 having two segments removably joined together. Separator rod 551 has a first segment 552 with pin 553 disposed on its surface. Separator rod 551 further has a second segment 554 with vertical groove 555 that penetrates the surface of said second segment and that is cooperatively connected to locking slot 556 for securing said pin. Locking slot 556 also penetrates the surface of second segment 554. Pin 553, vertical groove 555, and locking slot 556 operate cooperatively together whereby said vertical groove is configured to receive said pin and allow it to move to and from said locking slot, as well as allow said pin to exit said vertical groove. First segment 552 has optional telescoping portion 557 disposed between pin 553 and dispensing compartment 112 to extend and retract the length of separator rod 551. An optional swivel portion (not shown) of separator rod 551 may be disposed between pin 553 and dispensing compartment 112 to allow separator rod 551 to rotate.

FIG. 5A is an illustrative configuration that shows multi-level caddy 100 with separator rod 551 configured as a single piece and having a first end 558 disposed within a housing 559. Said housing is attached to an interior surface of the bottom wall of receptacle bin 126 and has a top side with an opening opposite the place of attachment to the bottom wall. First end 558 has a diameter greater than the diameter of the opening in the top side of housing 559, through which opening separator rod 551 moves up and down to raise and lower dispensing compartment 112. Such difference in diameters prevents said separator rod from exiting the housing. Separator rod 551 has a second end (not shown) attached to the surface of the bottom exterior of dispensing compartment 112. Optionally, separator rod 551 has a telescoping portion (not shown) located outside housing 559. An optional swivel portion (not shown) of separator rod 551 may be disposed outside housing 559 to allow separator rod 551 to rotate. As shown, separator rod 551 has rotated within housing 559 to allow easy access to receptacle bin 126.

In yet another illustrative embodiment of the disclosure, a multi-level caddy has one or more dispensing compartments and one or more receptacle bins. The dispensing compartment may have only one sidewall, where, for example, the single sidewall is curved to form a circle, oval, ellipse, or the dispensing compartment may have a plurality of sidewalls that when joined together can form a variety of shapes, such as a square, rectangle, star, cross, and other desired shapes. Similarly, the receptacle bin may have only one sidewall, where, for example, the single sidewall is curved to form a circle, oval, ellipse, or the receptacle bin may have a plurality of sidewalls that when joined together can form a variety of shapes, such as square, rectangular, star, cross, and other desired shapes. The shape of the dispensing compartment should generally, but need not, match the shape of the receptacle bin. As used herein, “circular shaped” means a multi-level caddy where the dispensing compartment and receptacle bin are both circular in shape and the circumference of the single sidewall of the dispensing compartment and the circumference of the single sidewall of the receptacle bin are approximately the same length. In this embodiment, the multi-level caddy is configured with a passageway connecting a portion of the interior space of the dispensing compartment to a portion of the interior space of the receptacle bin to allow waste to pass through the passageway into the receptacle bin. The passageway may be sited centrally or in other advantageous locations. Optionally, the passageway has a lid.

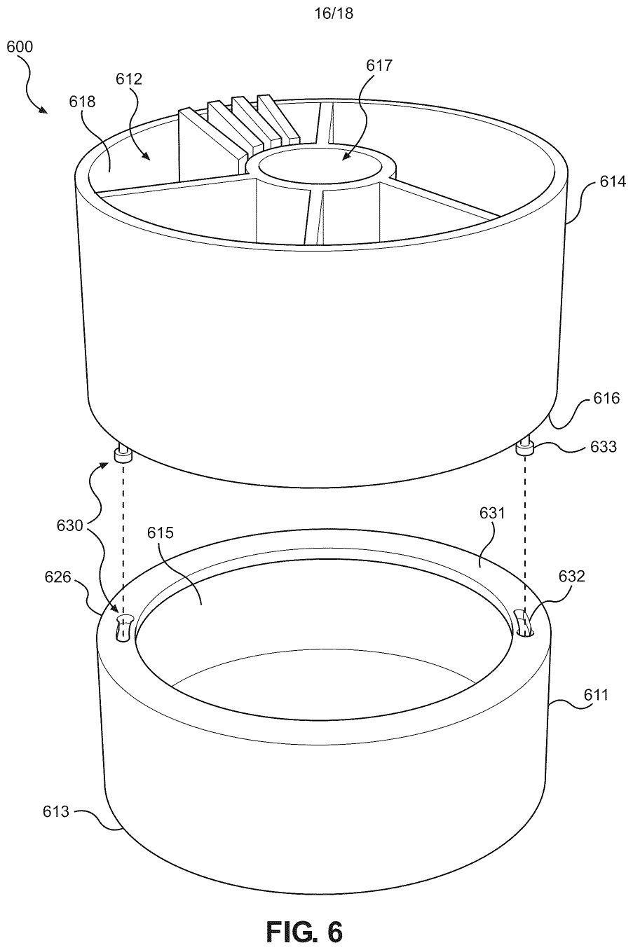

FIG. 6 depicts circular shaped multi-level caddy 600 having circular dispensing compartment 612 formed by joining a single sidewall 614 with a bottom wall 616 that together create an interior space 618. FIG. 6 further depicts said caddy having circular receptacle bin 626 formed by joining a single sidewall 611 with a bottom wall 613 to create an interior space 615. A portion of interior space 615 is disposed beneath interior space 618. Also shown is central passageway 617.

Optionally, receptacle bin 626 may be configured with one or more hinges (not shown) to access the interior space of a receptacle bin to aid removal of waste therefrom. Optionally, a portion of the sidewall or portion of the bottom wall of receptacle bin 626 may be removable from said receptacle bin to aid emptying of said receptable bin, such as when a sidewall or bottom wall is configured with tongue and groove edges, when a sidewall and bottom wall are magnetically attached, when such sidewall and bottom wall are adhesively attached for example with a hook and loop fastener, and the like.

Optionally, a dispensing compartment may be securely attached to and detached from a receptacle bin. Such removable attachment may be accomplished with a mechanical securing mechanism, magnetically, or adhesively for example with a hook and loop fastener, and the like. When said dispensing compartment and receptacle bin are attached, the caddy is beneficially more resistant to accidental toppling and the single piece is easier to transport than two separate pieces. When said dispensing compartment and receptacle bin are detached, the receptacle bin is easier to empty and the caddy is easier to clean. Continuing to refer to FIG. 6, exemplary mechanical securing mechanism 630 is shown, wherein sidewall 611 of receptacle bin 626 has a top edge 631 approximately perpendicular to said sidewall, and wherein top edge 631 has locking slots 632 for receiving and securing locking pins 633 cooperatively disposed on the exterior surface of bottom wall 616 of dispensing compartment 612.

Optionally, the dispensing compartment and receptacle bin may be attached to each other with a separator rod. The separator rod may be secured to an exterior surface of the bottom wall of the dispensing compartment and to an inside surface of the bottom wall of the receptacle bin. Alternatively, the separator rod is secured to the dispensing compartment and to the receptacle bin using other apparent combinations of surfaces, such as to an outside surface of a sidewall of the dispensing compartment and to an outside surface of a sidewall of the receptacle bin.

Optionally, the separator rod has a first end which resides within a first housing attached to either the receptacle bin or the dispensing compartment. The first housing allows the separator rod to rotate within it so that at least one of the bottom surfaces of the dispensing compartment and receptacle bin rotate parallel to the other bottom surface in the same plane when a lateral force is applied to the dispensing compartment or receptacle bin. Optionally, a second end of the separator rod may reside and rotate within a second housing. Optionally, the separator rod may rotate when it is configured as a swivel.

The separator rod length may be fixed or it may be extendable when configured with a telescoping portion. A separator rod with a telescoping portion may be additionally configured to have a first end disposed within a first housing to allow the separator rod to rotate within it.

Optionally, the separator rod may have two or more segments that may be detached from and reattached to each other and thereby attach and detach the dispensing compartment and receptacle bin. Such configuration for removable attachment is another exemplary mechanical securing mechanism. Optionally, the separator rod may be a single piece.

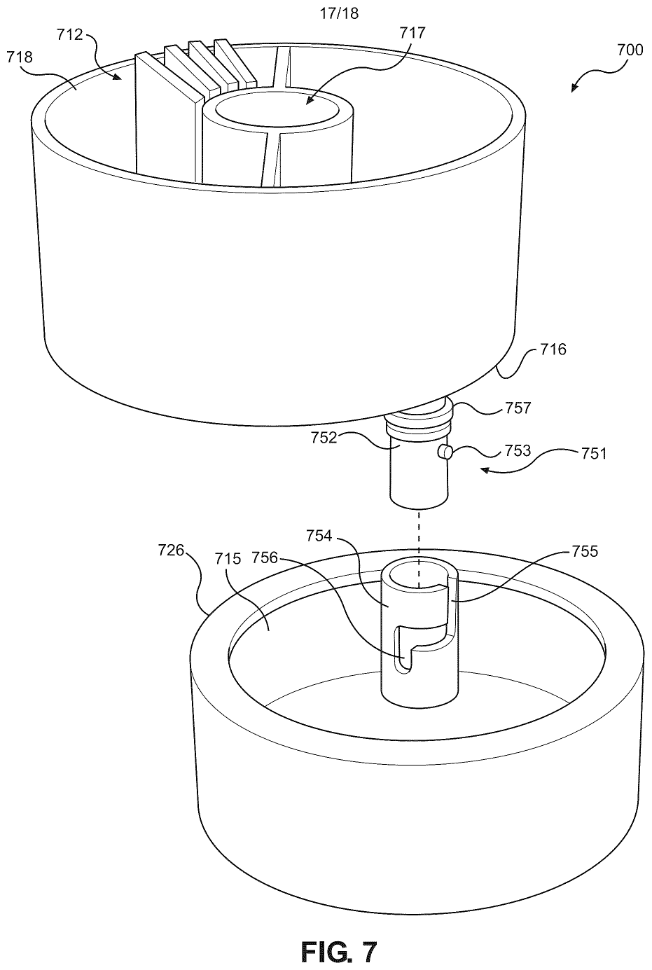

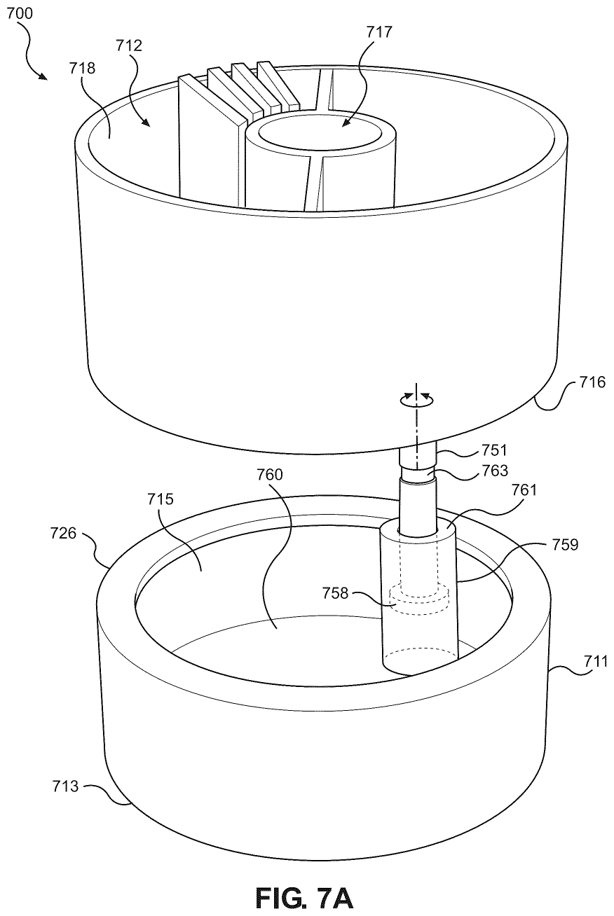

FIG. 7 shows multi-level caddy 700 with a portion of the interior space 715 of receptacle bin 726 disposed beneath a portion of the interior space 718 of dispensing compartment 712 with a central passageway 717. Separator rod 751 is shown having two segments removably joined together. Separator rod 751 has a first segment 752 with pin 753 disposed on its surface. Separator rod 751 further has a second segment 754 with vertical groove 755 that penetrates the surface of said second segment and that is cooperatively connected to locking slot 756 for securing said pin. Locking slot 756 also penetrates the surface of second segment 754. Pin 753, vertical groove 755, and locking slot 756 operate cooperatively together whereby said vertical groove is configured to receive said pin and allow it to move to and from said locking slot, as well as allow said pin to exit said vertical groove. First segment 752 has optional telescoping portion 757 disposed between pin 753 and dispensing compartment 712 to extend and retract the length of separator rod 751. An optional swivel portion (not shown) of separator rod 751 may be disposed between pin 753 and dispensing compartment 712 to allow separator rod 751 to rotate.

FIG. 7A is an illustrative configuration that shows multi-level caddy 700 with separator rod 751 configured as a single piece and having a first end 758 disposed within a housing 759. Said housing is attached to an interior surface 760 of the bottom wall of receptacle bin 726 and has a top side 761 with an opening opposite the place of attachment to the bottom wall. First end 758 has a diameter greater than the diameter of the opening in the top side of housing 759, through which opening separator rod 751 moves up and down to raise and lower dispensing compartment 712. Such difference in diameters prevents said separator rod from exiting the housing. Separator rod 751 has a second end (not shown) attached to the surface of the bottom exterior of dispensing compartment 712. Separator rod 751 rotates within housing 759 when a lateral force is applied to the dispensing compartment or receptacle bin. Optionally, separator rod 751 has a telescoping portion (not shown) located outside housing 759. An optional swivel portion 763 of separator rod 751 may be disposed outside housing 759 to allow separator rod 751 to rotate.

The foregoing descriptions of embodiments of the disclosure have been presented for purposes of illustration and exposition. They are not intended to be exhaustive or to limit the disclosed embodiments to the precise forms disclosed. Obvious modifications or variations are possible in light of the above teachings. The embodiments are chosen and described in an effort to provide the best illustrations of the principles of the disclosed embodiments and its practical application, and to thereby enable one of ordinary skill in the art to utilize the various embodiments and with various modifications as are suited to the particular use contemplated. All such modifications and variations are within the scope of the disclosure as determined by the appended claims when interpreted in accordance with the breadth to which they are fairly, legally, and equitably applied.

What is claimed is:

1. A single-level caddy comprising:
a dispensing compartment having a plurality of sidewalls joined with a bottom wall that together form an interior space, wherein each wall has an interior surface and an exterior surface, and
a receptacle bin having a plurality of sidewalls and a bottom wall joined together to form an interior space, wherein each wall has an interior surface and an exterior surface, and
a retainer secured to a sidewall, wherein
the retainer has an adjustable portion with a first end joined at an angle to a fixed portion of the retainer,
the fixed portion has a closed position that completely obstructs access to the entire dispensing compartment but does not obstruct access to any portion of the receptacle bin, and
the fixed portion has an open position that does not obstruct access to any portion of the dispensing compartment or to any portion of the receptacle bin.

2. (canceled)

3. (canceled)

4. (canceled)

5. (canceled)

6. (canceled)

7. (canceled)

8. (canceled)

9. The caddy of claim 1 wherein the dispensing compartment comprises multiple dispensing compartments of uniform or varying depth and width.

10. (canceled)

11. A single-level caddy comprising:
a dispensing compartment having a plurality of sidewalls joined with a bottom wall that together form an interior space, wherein each wall has an interior surface and an exterior surface, and
a receptacle bin having a plurality of sidewalls and a bottom wall joined together to form an interior space, wherein each wall has an interior surface and an exterior surface, and
a retainer secured to a sidewall, wherein
the retainer has an adjustable portion with a first end joined at an angle to a fixed portion of the retainer,
the fixed portion has a closed position that obstructs access to the dispensing compartment but does not obstruct access to the receptacle bin, and
the fixed portion has an open position that does not obstruct access to the dispensing compartment or to the receptacle bin, and
a connector assembly attached to the exterior surface of a sidewall of the dispensing compartment wherein the connector assembly is configured with a swivel.

12. The caddy of claim 11 wherein the dispensing compartment comprises multiple dispensing compartments of uniform or varying depth and width.

13. The connector assembly of claim 11 further comprising a closed channel.

14. The connector assembly of claim 11 further comprising a partially open channel.

15. The partially open channel of claim 14 wherein the partially open channel includes flexible material.

16. A single-level caddy comprising:
a dispensing compartment having a plurality of sidewalls joined with a bottom wall that together form an interior space, wherein each wall has an interior surface and an exterior surface, and
a receptacle bin having a plurality of sidewalls and a bottom wall joined together to form an interior space, wherein each wall has an interior surface and an exterior surface, and
a retainer secured to a sidewall, wherein
the retainer has an adjustable portion with a first end joined at an angle to a fixed portion of the retainer,
the fixed portion has a closed position that obstructs access to the dispensing compartment but does not obstruct access to the receptacle bin, and
the fixed portion has an open position that does not obstruct access to the dispensing compartment or to the receptacle bin, and wherein
the exterior surface of a sidewall has a hole, and wherein
the adjustable portion of the retainer further comprises a second end having a stub segment at an angle and at least partially inserted through the hole.

17. The stub segment of claim 16 further comprising one of an end cap or a cotter pin assembly.

18. The caddy of claim 16 wherein the dispensing compartment comprises multiple dispensing compartments of uniform or varying depth and width.

19. A single-level caddy comprising:
a dispensing compartment having a plurality of sidewalls joined with a bottom wall that together form an interior space, wherein each wall has an interior surface and an exterior surface, and
a receptacle bin having a plurality of sidewalls and a bottom wall joined together to form an interior space, wherein each wall has an interior surface and an exterior surface, and
a retainer secured to a sidewall, wherein
the retainer has an adjustable portion with a first end joined at an angle to a fixed portion of the retainer,
the fixed portion has a closed position that obstructs access to the dispensing compartment but does not obstruct access to the receptacle bin, and
the fixed portion has an open position that does not obstruct access to the dispensing compartment or to the receptacle bin, and wherein
the sidewall attached to the retainer has a notch in a bottom edge of the sidewall and wherein the caddy is configured with an internal cavity beneath the bottom walls of the caddy.

20. The caddy of claim 19 wherein the dispensing compartment comprises multiple dispensing compartments of uniform or varying depth and width.
